(19) United States
(12) Patent Application Publication
(10) Pub. No.: US 2008/0295261 A1
(43) Pub. Date: Dec. 4, 2008

(54) Anthraquinone Dyes For Coloring Polyurethane

(75) Inventors: Hartwig Jordan, Bergisch-Gladbach (DE); Werner Russ, Floersheim-Wicker (DE)

Correspondence Address: CONNOLLY BOVE LODGE & HUTZ, LLP, P O BOX 2207, WILMINGTON, DE, 19899, US

(73) Assignee: DyStar Textifarben GmbH & Co. Deutschland KG, Frankfurt am Main (DE)

(21) Appl. No.: 12/094,830

(22) PCT Filed: Dec. 1, 2006
(86) PCT No.: PCT/EP2006/069200

§ 371 Date: May 23, 2008

(30) Foreign Application Priority Data
Dec. 9, 2005 (DE) 10 2005 058 906.5

(51) Int. Cl. C09B 1/54; C09B 69/10; C08K 5/23

(52) U.S. Cl. 8/515; 8/675

(57) ABSTRACT

The invention relates to a dye of the formula I

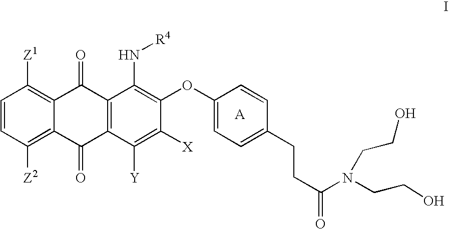

wherein
the phenylene ring A is unsubstituted or singly or multiply substituted by C₁-C₄-alkyl, halogen, aryl, CF₃, CN, C₁-C₄-alkoxy, COR¹, COOR¹, CONR²R³, SO₂R¹ or SO₂NR²R³,
wherein
R¹ is C₁-C₄-alkyl, which is optionally substituted, or is aryl,
R² and R³ are independently hydrogen, C₁-C₄-alkyl, which is optionally substituted, or aryl;
R⁴ is C₁-C₄-alkyl;
X is hydrogen, Cl or Br,
Y is OH or NHR⁴; and
Z¹ and Z² are independently hydrogen or halogen. The invention also relates to a method for the production of the dye of the formula (I). The invention further relates to a colored polyurethane and method of producing the colored polyurethane.

Polyurethanes are manufactured polymers obtained by polyaddition of building blocks that contain at least two hydroxyl groups and are known as diols with building blocks that contain at least two isocyanate groups and are known as diisocyanates. Polyurethanes are generally produced as foams by generating carbon dioxide through specific inclusion of water during the polycondensation, or by adding gases from the outside.

Colored polyurethanes are generally produced by admixing one of the two components, namely the diol, with a dye containing at least one functional group capable of reacting with the other component, the diisocyanate, to form a covalent bond. The dye is thus incorporated in the polyadduct by means of chemical bonds, and is no longer removable by operations involving washing off. Hydroxyl groups have been determined to be particularly useful as functional groups, and generally two of these groups are incorporated in the dye molecule. The hydroxyl groups may be situated at the end of long chains obtainable by reaction with ethylene oxide or propylene oxide of dyes containing nucleophilic groups. Such dyes are often liquid at room temperature and can be added in highly concentrated form to the foaming system (see for example EP 0 166 566 A2).

However, it is also possible to use solid dyes which are ground in the diol component and then added as a dispersion to the foaming system. Such dyes have the advantage that their as-synthesized form is more easily convertible into a pure form, for example by filtering operations. Dyes of this kind are already known and are described for example in DE 2 259 435, DE 2 357 933 and EP 0 014 912 A1. However, it is still not possible to achieve every commercially desired hue, in particular in the brilliant range. Using mixtures to achieve certain hues is difficult, since the dyes often differ in their thermal characteristics, which results in unlevel colorations.

Surprisingly, it has now been found that bright bluish red colorations and blue colorations are obtained without foam structure disruptions and with very good washfastnesses on using certain dyes of the general formula I given below.

One dye of this general formula I, wherein the phenylene ring A is unsubstituted, X, Z¹, Z² and R⁴ are each hydrogen and Y is OH, is already known from the literature. JP 44015316 and DE 1619602 describe the use of this compound for dyeing and printing synthetic fibrous materials. They do not describe intercondensation into polyurethanes or polyurethane foams for the purposes of their coloration.

The present invention accordingly provides dyes of the general formula I

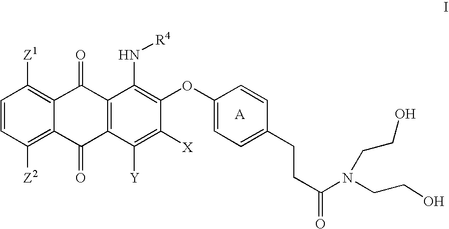

where
the phenylene ring A may be unsubstituted or singly or multiply substituted by C₁-C₄-alkyl, halogen, aryl, CF₃, CN, C₁-C₄-alkoxy, COR¹, COOR¹, CONR²R³, SO₂R¹ or SO₂NR²R³, where
R¹ is C₁-C₄-alkyl, which may be substituted, or is aryl,
R² and R³ are each hydrogen, C₁-C₄-alkyl, which may be substituted, or aryl;
R⁴ is C₁-C₄-alkyl;
X is hydrogen, Cl or Br,

### Y is OH or NHR⁴; and

Z¹ and Z² are independently hydrogen or halogen.

C₁-C₄-Alkyl groups, which may be straight chain or branched, are for example methyl, ethyl, n-propyl, isopropyl, n-butyl, isobutyl, sec-butyl or tert-butyl, of which methyl and ethyl are preferred. The same applies to C₁-C₄-alkoxy groups, mutatis mutandis, so methoxy and ethoxy are preferred.

Halogen is for example fluorine, chlorine or bromine, of which fluorine and chlorine are preferred.

Aryl is for example phenyl or naphthyl.

Examples of substituents on C₁-C₄-alkyl groups are in particular hydroxyl and halogen, of which hydroxyl, bromine and chlorine are very particularly preferred.

Preference is given to dyes of the general formula Ia

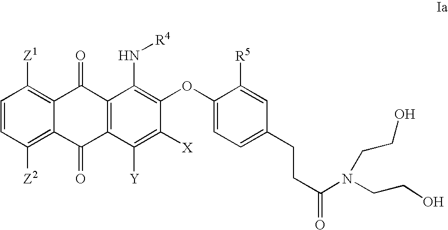

where
R⁵ is hydrogen, C₁-C₄-alkyl or halogen and Z¹, Z², Y, X and R⁴ are each as defined above.

Particular preference is given to dyes of the general formula Ia wherein

R⁵ is hydrogen, methyl or ethyl;
Z¹ and Z² are independently hydrogen or chlorine;

### Y is OH or NHR⁴;

X is hydrogen, chlorine or bromine; and
R⁴ is hydrogen, methyl or ethyl.

The present invention's dyes of the general formula I or Ia are obtainable in a conventional manner.

For instance, a compound of the general formula II

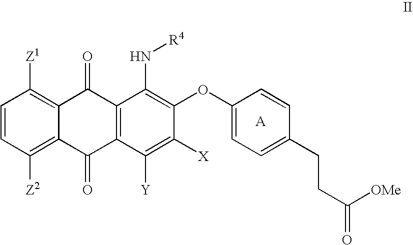

where A, X, Y, Z¹, Z² and R⁴ are each as defined above, can be reacted with diethanolamine of the formula III

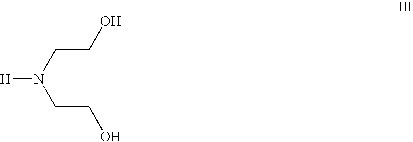

to form a compound of the general formula I.

The reaction is generally carried at out elevated temperature, preferably at 80-120° C. The reaction may be carried out in the presence of inert solvents, but it is also possible to carry it out with the use of diethanolamine only.

The compounds of the general formula II are obtainable for example by reacting a nitrile of the general formula IV

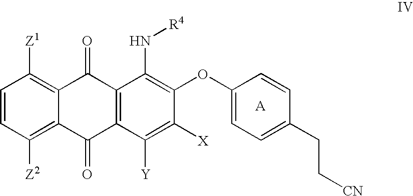

where A, X, y, Z¹, Z² and R⁴ are each as defined above, with methanol and concentrated sulfuric acid,

The compounds of the formula IVa

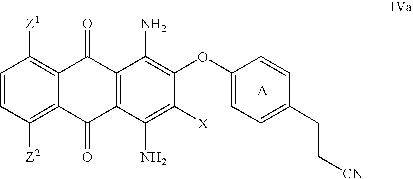

where A, X, Z¹ and Z² are each as defined above, are simultaneously converted in this reaction into the corresponding 1,4-bis(monomethylamino)anthraquinones by N-alkylation.

The compounds of the general formula IV are obtainable by reaction of the compounds of the general formula V

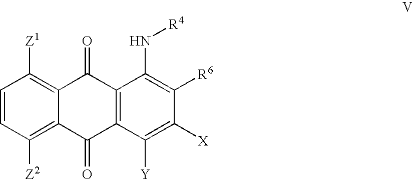

where X, Y, Z¹, Z² and R⁴ are each as defined above and R⁶ is chlorine or bromine, with phenols of the general formula VI

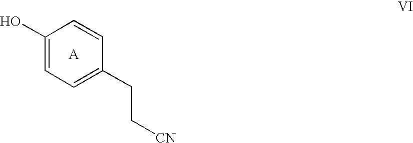

where A is as defined above, preferably in the presence of bases.

The compounds of the general formula V and VI are known and are obtainable by known methods.

The present invention also provides a process for producing colored polyurethane by polycondensation of a diol component with a diisocyanate component in the presence of a dye, wherein said dye conforms to the general formula I

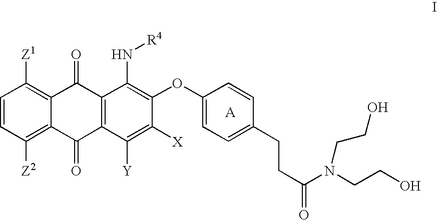

where
the phenylene ring A may be unsubstituted or singly or multiply substituted by C₁-C₄-alkyl, halogen, aryl, CF₃, CN, C₁-C₄-alkoxy, COR¹, COOR¹, CONR²R³, SO₂R₁ or SO₂NR²R³, where
R¹ is C₁-C₄-alkyl, which may be substituted, or is aryl,
R² and R³ are each hydrogen, C₁-C₄-alkyl, which may be substituted, or aryl;
R⁴ is hydrogen or C₁-C₄-alkyl;
X is hydrogen, Cl or Br,

### Y is OH or NHR⁴; and

Z¹ and Z² are independently hydrogen or halogen.

The polycondensation of the diol component with the diisocyanate component is carried out according to methods which have been previously described and which are known to one skilled in the art (see for example EP 0 166 566 A2, EP 0 810 266 A2 and the references cited therein). In the course of the polycondensation, the dye of the general formula I becomes incorporated in the polyurethane structure via covalent bonding through its hydroxyl groups.

The dye of the general formula I may be added to the reaction mixture of diol component and diisocyanate component before or during the polyaddition reaction. Preferably, however, the dye is added to the diol component before the diol component comes into contact with the diisocyanate component.

The process of the present invention is particularly advantageous for producing colored polyurethane foams. The polyurethane foams are produced according to the customary methods which are customary for the production of noncolored polyurethane foams and are known to one skilled in the art.

For example, the present invention's dye of the general formula I can be admixed to a polyether polyol or a polyester polyol and this preparation can then be used for the polyaddition with a diisocyanate.

The polyether polyols and polyester polyols contain at least two and preferably at least three hydroxyl groups. Polyester polyols are obtainable for example by reaction of phthalic acid or adipic acid with polyalcohols, examples being glycol, diethylene glycol, triethylene glycol, 1,4-butanediol, glycerol or trimethylolpropane.

Polyether alcohols are obtained for example by etherifying the aforementioned alcohols in a conventional manner.

The diisocyanates may be aliphatic and aromatic in nature and may also contain more than two isocyanate groups. Tolylene diisocyanate (TDI) and diphenylmethane diisocyanate (MDI) are the most common.

The ratio of polyol to diisocyanate depends on the molar masses, and it is normal to use a small excess of the diisocyanate. The molar ratio of polyol to diisocyanate can be for example between 1:0.85 to 1:1.1.25. To produce more rigid foams, it is generally customary to use diisocyanate excesses of 100-300%.

The addition polymerization customarily utilizes stabilizers and activators or catalysts.

Preferred stabilizers are for example silicones, which may comprise between 0.1% and 2% by weight and preferably between 0.5% and 1.6% of the entire foam-forming mixture.

Possible activators are amines, preferably tertiary amines. They may comprise 0.05% to 1% by weight and preferably 0.07% to 0.6% of the mixture.

Polyurethane foam is produced according to the same principle, the foam being produced by the addition of blowing gas or by the addition of water to the diol/polyol component, leading to the formation of carbon dioxide blowing gas. The production of colored polyurethane foams is described in detail in US 2004/0254335 for example.

By using the present invention's dyes of the general formula I it is thus possible to produce colored polyurethane foams having no disruptions in foam structure and good fastnesses, that likewise form part of the subject matter of the present invention.

The examples which follow illustrate the invention:

### EXAMPLE 1

245 parts of concentrated sulfuric acid are added dropwise to 101 parts of methanol with cooling and stirring at not more than 30° C. At this temperature, 100 parts of the C.I. Disperse Violet 46 dye of the formula IVb

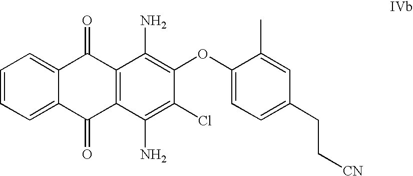

are introduced. This is followed by a stirring at reflux temperature for 8 hours. Thereafter, the batch is cooled down to 70° C., admixed with 651 parts of methanol, then stirred at 63° C. for 2 hours and then cooled down to room temperature. The batch is poured onto 200 parts of ice and adjusted with aqueous sodium hydroxide solution to pH 6-7. After filtration and washing with water, the filter residue cake obtained (200 parts moist) is suspended once more in 1000 parts of water and adjusted to pH 5 with aqueous sodium hydroxide solution. As soon as the pH is constant, the solids are filtered off, washed with water and dried to leave 114 parts (corresponds to 100% of theory) of the dye of the formula IIa

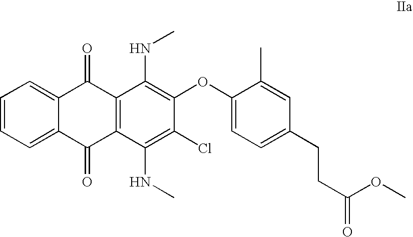

whose melting point is 121° C.

56.8 parts of the dye IIa are introduced into 165 parts of diethanolamine and heated to 100° C. The batch is stirred at 100° C. for 13 hours and then allowed to cool down to room temperature. After pouring into 300 parts of water and allowed to settle, the water phase is decanted off. The oily residue is re-suspended in 300 parts of water and adjusted to pH 7 with 30% hydrochloric acid. The dye crystallizes and is isolated by filtration and washing with water. Drying at 50° C. under reduced pressure leaves 50 parts (76% of theory) of the blue dye of the formula Ib

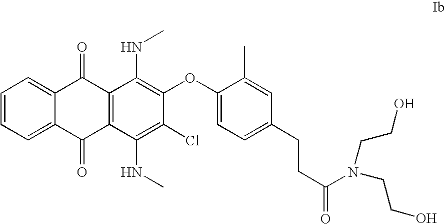

Melting point: 84-86° C.

UV/Vis of IX: λₘₐₓ=584 nm (ε=13750|×mol⁻¹×cm⁻¹)

(in DMF), λₘₐₓ=624 nm (ε=12890|×mol⁻¹×cm⁻¹)

### EXAMPLE 2

588 parts of a compound of the formula IIb

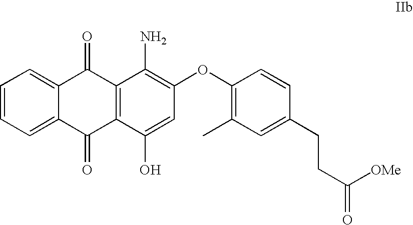

are introduced into 1645 parts of diethanolamine and heated to 100° C. The batch is stirred at 100° C. for 5 h and then poured onto 3000 parts of water. pH is set to 7 with about 1630 parts of 30% hydrochloric acid. The dye is filtered off and thoroughly washed with water. Drying leaves 642 parts of a red dye of the formula Ic

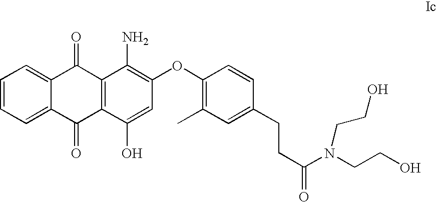

which corresponds to 93% of theory. The dye can be recrystallized from chlorobenzene or methanol.

Melting point: 155-157° C.

UV/Vis λₘₐₓ=520 nm (ε=15065 l×mol⁻¹×cm⁻¹)

(in DMF) λₘₐₓ=556 nm (ε=13229 l×mol⁻¹×cm⁻¹)

The table hereinbelow shows further examples of inventive dyes of the general formula I which are obtainable similarly to the synthesis examples described above.

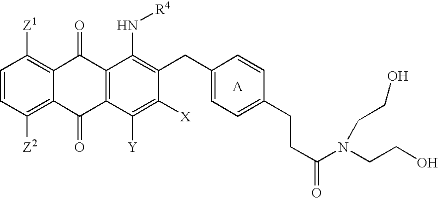

| Example | 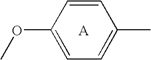 | R⁴ | X | Y | Z¹ | Z² | Hue |
|---|---|---|---|---|---|---|---|
| 3 | 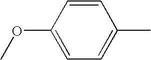 | Me | Cl | NHMe | H | H | blue |
| 4 | 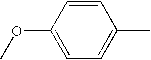 | Me | Br | NHMe | H | H | blue |
| 5 | 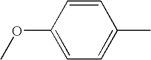 | H | Br | NH₂ | H | H | blue |
| 6 | 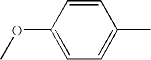 | H | Cl | NH₂ | H | H | blue |
| 7 | 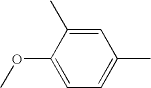 | H | Br | NH₂ | H | H | blue |
| 8 | 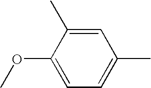 | H | Cl | NH₂ | H | H | blue |
| 9 | 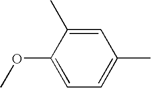 | H | Cl | NH₂ | Cl | Cl | blue |
| 10 | 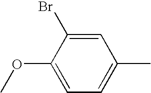 | H | H | OH | H | H | red |
| 11 | 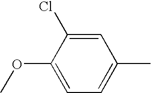 | H | H | OH | H | H | red |
| 12 | 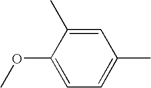 | H | H | OH | Cl | Cl | red |
| 13 | 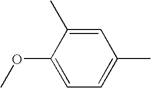 | H | H | OH | H | Cl | red |

### EXAMPLE 14

100 parts of the Elastopan S 7521/102 polyol component from Elastogran GmbH are presented as an initial charge. Three parts of a color paste obtained by bead-milling 100 parts of the dye of Example 2 with 900 parts of Ultramoll® M nv, from Lanxess are added. Everything is stirred together intensively using a dissolver disk for 20-30 sec. Then, 60 parts of IsoMMDI 92220 diisocyanate from Elastogran GmbH are speedily added before intensive mixing together for 7 sec by means of the dissolver disk. The contents are then poured into a vessel to form the foam, for which cups made of paper or paperboard are suitable. After about 5 min, the components will have reacted off and after a further 10 min the foam will have cured. It is allowed to cool down to room temperature. 20 minutes after cooling down, the foam can be sawn open to assess its hue. The foam obtained has a bright bluish red color, no foam disruptions and has very good washfastnesses.

Repeating the foaming described with the dyes of Examples 1 and 3-13 gives red or blue foams without foam disruptions and having very good washfastnesses.

1-7. (canceled)

8. A dye of the formula I 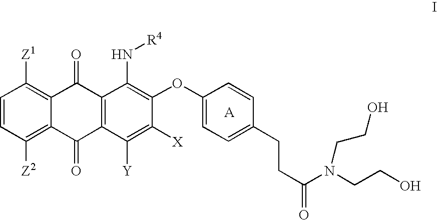
wherein
the phenylene ring A is unsubstituted or singly or multiply substituted by C₁-C₄-alkyl, halogen, aryl, CF₃, CN, C₁-C₄-alkoxy, COR¹, COOR¹, CONR²R³, SO₂R₁ or SO₂NR²R³, wherein
R¹ is C₁-C₄-alkyl, which is optionally substituted, or is aryl,
R² and R³ are independently hydrogen, C₁-C₄-alkyl, which is optionally substituted, or aryl;
R⁴ is C₁-C₄-alkyl;
X is hydrogen, Cl or Br,
Y is OH or NHR⁴; and
Z¹ and Z² are independently hydrogen or halogen.

9. The dye as claimed in claim 8, conforming to the formula Ia 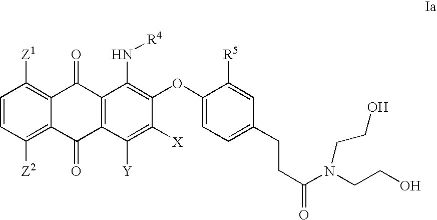
wherein
R⁵ is hydrogen, C₁-C₄-alkyl or halogen and Z¹, Z², Y, X and R⁴ are each as defined in claim 8.

10. The dye as claimed in claim 9, wherein
R⁵ is hydrogen, methyl or ethyl;
Z¹ and Z² are independently hydrogen or chlorine;
Y is OH or NHR⁴;
X is hydrogen, chlorine or bromine; and
R⁴ is hydrogen, methyl or ethyl.

11. A process for preparing a dye as claimed in claim 8, which comprises reacting a compound of the formula II 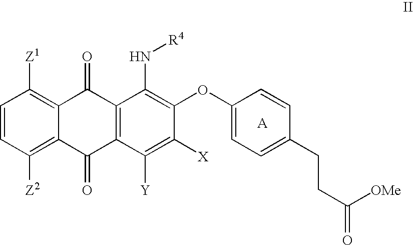
wherein
the phenylene ring A is unsubstituted or singly or multiply substituted by C₁-C₄-alkyl, halogen, aryl, CF₃, CN, C₁-C₄-alkoxy, COR¹, COOR¹, CONR²R³, SO₂R¹ or SO₂NR²R³, wherein
R¹ is C₁-C₄-alkyl, which is optionally substituted, or is aryl,
R² and R³ are independently hydrogen, C₁-C₄-alkyl, which is optionally substituted, or aryl;
R is C₁-C₄-alkyl;
X is hydrogen, Cl or Br,
Y is OH or NHR⁴; and
Z¹ and Z² are independently hydrogen or halogen,
with diethanolamine of the formula III 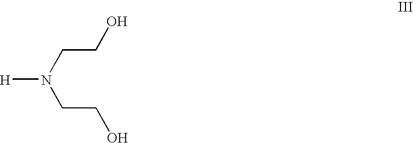
to form a compound of the formula I.

12. A process for producing colored polyurethane which comprises polycondensation of a diol component with a diisocyanate component in the presence of a dye, wherein said dye conforms to the formula I 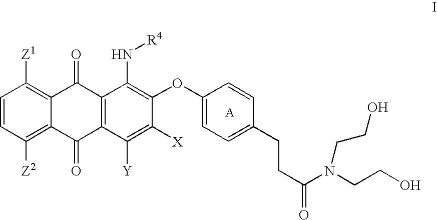
wherein
the phenylene ring A is unsubstituted or singly or multiply substituted by C₁-C₄-alkyl, halogen, aryl, CF₃, CN, C₁-C₄-alkoxy, COR¹, COOR¹, CONR²R³, SO₂R¹ or SO₂NR²R³, wherein
R¹ is C₁-C₄-alkyl, which is optionally substituted, or is aryl,
R² and R³ are each hydrogen, C₁-C₄-alkyl, which is optionally substituted, or aryl;
R⁴ is hydrogen or C₁-C₄-alkyl;
X is hydrogen, Cl or Br,
Y is OH or NHR⁴; and
Z¹ and Z² are independently hydrogen or halogen.

13. The process as claimed in claim 12, wherein the polyurethane is produced in the form of a foam.

14. A colored polyurethane, colored with a dye of the general formula I 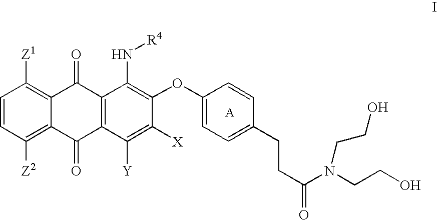
wherein
the phenylene ring A is unsubstituted or singly or multiply substituted by C₁-C₄-alkyl, halogen, aryl, CF₃, CN, C₁-C₄-alkoxy, COR¹, COOR¹, CONK²R³, SO₂R¹ or SO₂NR²R³, wherein
R¹ is C₁-C₄-alkyl, which is optionally substituted, or is aryl,
R² and R³ are independently hydrogen, C₁-C₄-alkyl, which is optionally substituted, or aryl;
R⁴ is C₁-C₄-alkyl;
X is hydrogen, Cl or Br,
Y is OH or NHR⁴; and
Z¹ and Z² are independently hydrogen or halogen.
